(19) United States
(12) Patent Application Publication
(10) Pub. No.: US 2016/0281756 A1
(43) Pub. Date: Sep. 29, 2016

(54) A PLUG FOR WET ROOMS, A WAY TO PRODUCE THE PLUG AND A METHOD FOR FITTING THE SAME

(71) Applicant: WPlug AB, Molndal (SE)

(72) Inventor: Peter Andersson, Molndal (SE)

(21) Appl. No.: 14/778,011

(22) PCT Filed: Mar. 4, 2014
(86) PCT No.: PCT/SE2014/050256

§ 371 Date: Sep. 17, 2015

(30) Foreign Application Priority Data
Mar. 22, 2013 (SE) 1330024-9

(51) Int. Cl. F16B 13/02

(52) U.S. Cl. CPC F16B 13/02; F16B 2013/006

(57) ABSTRACT

The invention concerns a plug designed to be used in wet rooms that have a wet room sealing layer, where the plug consists of a plastic plug provided with pre-thinned slits intended for screws in holes drilled into the intended wall, ceiling or floor. According to the invention, the plug is filled with the required quantity of sealant intended for wet rooms. The plug is provided with a foiled closure in the rear end of the plug and pre-thinned slits, which are airtight and made of the same plastic material that the plug consists of or other suitable material having the property of being airtight and with the ability to break up due to internal pressure in the plug from the inside of the plug screwed into the screw, situated in the sides of the plug are airtight, whereby when a screw penetrates the closure and enters the prepared airtight plug, the sealing medium is pushed through the slitted plug and out towards the mounting wall, etc. inside the drilled hole and out towards the object that will be installed, whereby the sealing layer in the wall, etc. is resealed. The invention also refers to a way to produce the plug and a method for mounting the plug.

### TECHNICAL FIELD

The present invention concerns a plug made of plastic designed to be used in wet rooms with a sealing layer, where the plug consists of a plastic plug with pre-thinned slits designed for screws in holes drilled into the intended wall, ceiling or floor.

The invention also concerns a way of producing the plastic plug with pre-thinned slits and designed to be used in holes drilled into the intended wall, ceiling or floor in wet rooms with a wet room sealing layer.

Finally, the invention concerns a method for the installing of objects in floors, walls or ceilings in wet rooms with a sealing layer, such as a toilet or fixture by drilling holes, plugging, applying a sealant and installing the object using screws.

### PRIOR ART

Today when someone breaks the wet room sealing layer, it is the person's responsibility to reseal the wet room sealing layer to its original sealing condition. Take for example a plumber who is going to fit a toilet. He has to put the toilet into position, mark out its position, remove the toilet again, drill holes, plug, apply a sealant, and put the toilet back again. After that he has to insert the screws correctly, for a correct installation. An electrician, who is going to mount lighting onto a wall, currently has to hold up the fitting, mark out its position, drill holes, plug and apply a sealant. After that he has to keep the fitting in the right position so as to correctly insert the screws, to achieve a correct installation.

With the currently known technique the necessary sealing is applied using a sealant gun containing the intended sealant. After a hole has been drilled through e.g. tile, plaster and into the intended wall, ceiling or floor a plastic plug of known type is put into the drilled hole. After that, he applies a little sealing agent there using the sealant gun. More often the screw misses rather than securely screwing into the plug and it pulls on the side of the plug, which results in an incorrect installation. In addition, he has no greater control of the quantity of sealant that is squirted in. Sometimes it can also be cumbersome to drag around a bulky sealant gun as well as fresh sealant. For private individuals who intend to install a number of objects in their new bathroom it is a requirement to acquire a sealant gun with fresh sealant. This can then be thought of as an unnecessary safety measure which is why they simply fail to reseal the broken sealing layer, which can have devastating consequences in the event of a possible water leak. The insurance company therefore also becomes more careful when it comes to achieving an adequate sealing layer. This applies to all professional groups who fit installations in wet rooms and also to private individuals who renovate or build themselves.

Example of plugs with sealant are shown in for example DE 10010473A1; US 2005/0058522 A1; DE 4006506 A1; FR 2170763 and DE Gebrausmuster 7134660, where the plugs include a fixing medium which is designed for plugs and/or anchoring sleeves on the front portion in intended hole for this.

Nothing however is specified about any sealing plugs with the enclosed sealing material which is intended to repair the sealant in the wet area damaged by drilling.

Nor do the above-mentioned publications refer to, or are identical to, the inclusion of a wet room surface layer in an airtight plug with pre-thinned slits and which is also closed at its mouth with airtight foil where the slits are first broken through when screwing the products intended and wished to be mounted using the invented plug.

Thus, the aforementioned publications, neither individually nor in combination, disclose any such plugs intended to be used in wet areas or a way to produce the plugs. Nor is any method disclosed to use an aforementioned wet room sealing method with a plug for this.

### Solution to the Problem

The primary purpose of the present invention is therefore by simple and well-functioning means to solve the aforementioned problem safely and effectively.

The aforementioned problem referred to is solved with the present invention the relevant plug, a method of production and a mounting method for the plug.

The aforementioned purpose is achieved by means of a plug, a method of production and a mounting method for the plug of the above specified type, which is substantially characterised by,
that the plug is filled with the required quantity of sealant designed for wet rooms, that the plug is supplied with a foliated closure in the rear end of the plug and that the aforementioned pre-thinned slits, which are airtight and which consist of the same plastic material that the plug consists of or of another suitable material that has the property of being airtight and with the ability to break up due to internal pressure in the plug from inside the plug's screwed-in screw, which are situated in the sides of the plug are airtight, by which means when a screw penetrates the closure and enters into the prepared airtight plug, the sealing agent is pressed out through the plug with splits and out towards the mounting wall, etc. into the drilled hole and out towards the object that will be mounted, whereby the sealing layer in the wall, etc. is resealed,
that the plug, which has airtight slits, which is airtight and which consists of the same plastic material that the plug consists of or another suitable material which has the property of being airtight and with the ability to break up due to internal pressure in the plug from inside the plug's screwed-in screw, in the sides, is filled with the required quantity of sealant designed for wet rooms after which the plug is provided with a foliated closure at the rear end of the plug whereupon the plug is airtight up to mounting of the same,
or that after drilling through the wet room surface layer an airtight plug is placed which is prepared with a sealant for wet rooms, that then the screw is screwed into the plug so that the sealant seeps out from the plug by emerging out from the plug through the pre-thinned slits provided for the plug, towards the mounting wall into the drilled hole and out towards the screw head and the object that is to be mounted, whereupon the sealing surface is resealed.

### LIST OF ILLUSTRATIONS

The invention is described in the following as a presented design example, with reference to the attached drawings, of which

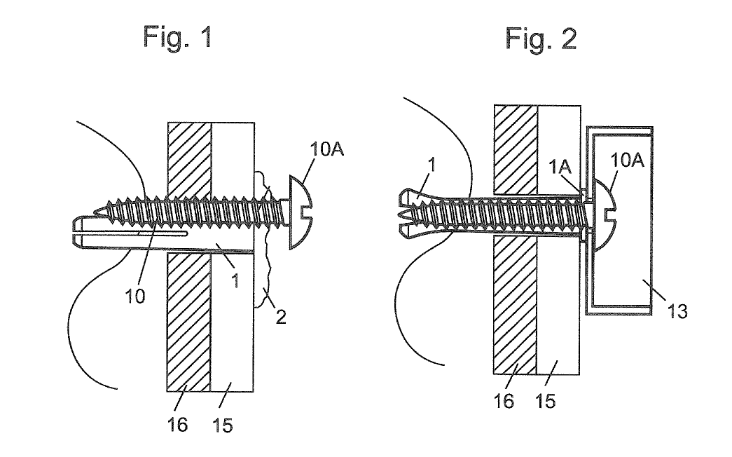

FIG. 1-2 shows an example of mounting with a plug of a known type,

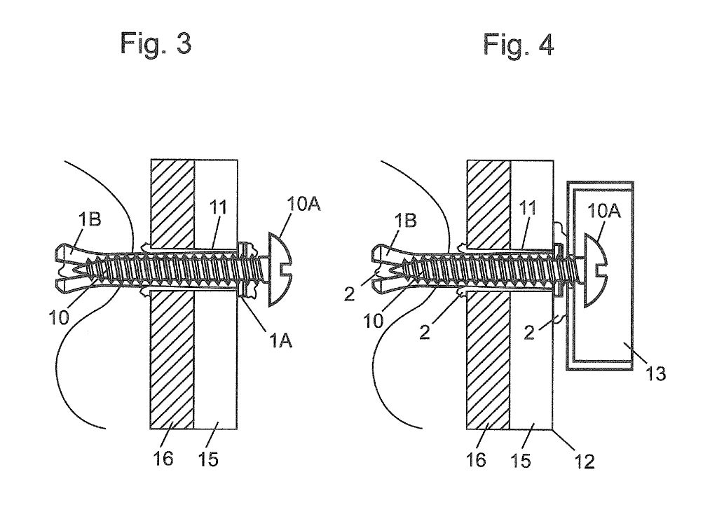

FIG. 3 shows a surface section of a plug according to the invention in mounted position,

FIG. 4 shows the plug according to the invention in a mounted position with an object that is installed with the plug,

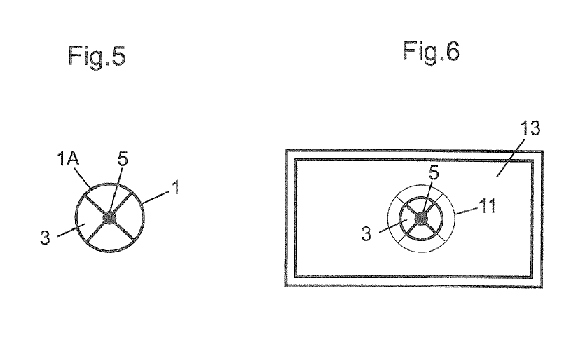

FIG. 5 shows an end view of a plug according to the invention with the centring guide on it,

FIG. 6 shows an intended object which is mounted with a plug according to the invention and on which a centring guide is shown on the plug,

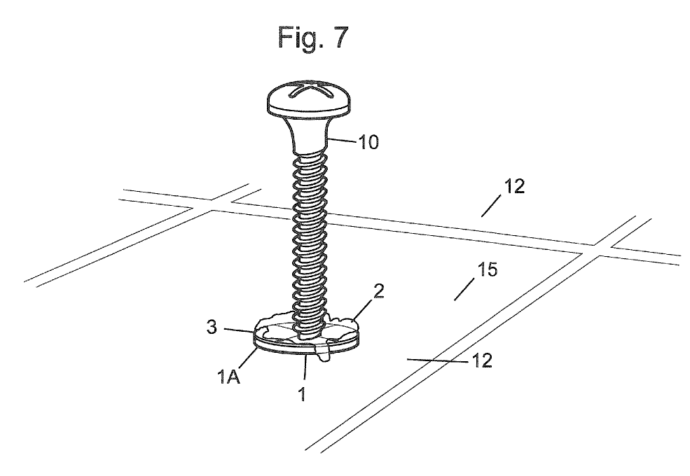

FIG. 7 shows a diagonal perspective view from above of a screw and plug in mounted position,

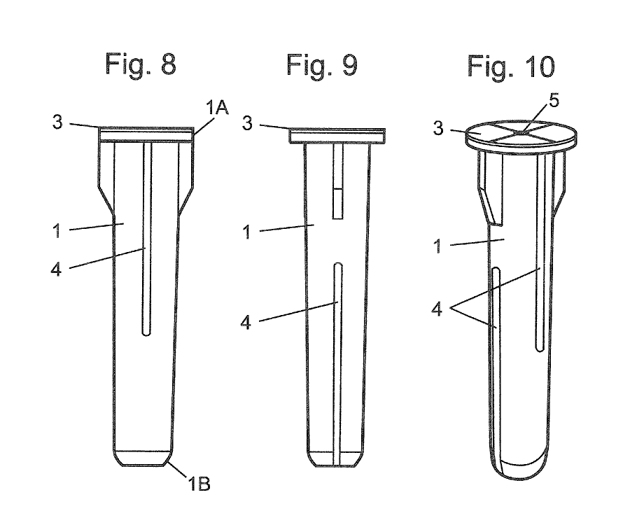

FIG. 8-10 shows side views of a plug according to the invention viewed from different directions, and

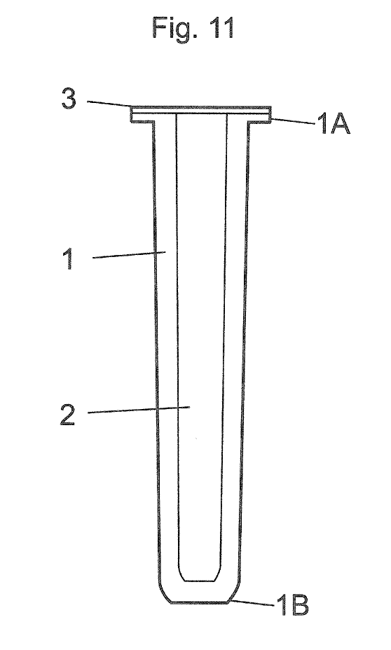

FIG. 11 shows a longitudinal section view of a plug according to the invention in mounted prepared position.

### SOLUTION TO THE PROBLEM

The invention makes it possible to carry out a safe, easy and correct installation and one that is time-saving for the fitters. In addition, it is also easier for private individuals to avoid carelessness, or completely ignore correct mounting. You also avoid the inconvenience of carrying around a sealant gun and intended sealant. It is of course easier to carry a small packet of the prepared plastic plugs, which lead to more correct mounting. You only use the required quantity of sealant, which is also environment saving.

### DETAILED DESCRIPTION OF THE INVENTION

The so-called wet-room plug 1, which is designed and arranged to be used in wet rooms that have a wet room surface layer in accordance with the regulations and standards for this, consists of a plastic plug 1 provided with pre-thinned slits 4 which are designed for screws 10 in drilled or in another way created hole 11 in the intended wall 12, ceiling or floor. The plug 1 is filled with the required quantity of sealant 2 which is intended for the sealing of holes 11 in wet rooms. The plug 1 is provided with a foliated closure 3 in the rear end of the plug 1A and which is preferably provided with a centring guide 5 on this, for example such as shown in the drawings in FIGS. 5, 6 and 10 with a cross hole. The aforementioned pre-thinned slits 4, which are airtight and which consist of the same plastic material that the plug consists of or of another suitable material that has the property of being airtight and with the ability to break up due to internal pressure in the plug from inside the plug's screwed-in screw, formed by thin airtight slits 4 which are so tight that they keep the contained sealant 2 fresh and soft but are still so thin or in another way are weakened so that upon screw 10 being screwed into the plug 1 they expand and extend, such as the previously known screw does, but which however is not airtight and which does not contain sealant. When the screw 10 penetrates the closure 3 and enters into the prepared plug 1 the sealing agent 2 is pressed out through the pre-thinned slits 4 from the plug 1, towards the mounting wall into the drilled hole 11, and out towards the object 13 that will be mounted. In this way the sealing layer is resealed. This takes place through the screw's properties upon being screwed into, similar to an ice drill, which drives the ice towards the surface during ice drilling.

One way to produce a perforated plastic plug 1 as specified above and intended to be used in a hole 11 drilled into the intended wall 12, ceiling or floor in a wet room which has a wet room sealing layer entails the plug 1, which has airtight pre-thinned slits 4, which are airtight and which consist of the same plastic material as the plug consists of or of another suitable material which has the property of being airtight and with the ability to break up due to internal pressure in the plug from inside the plug's screwed-in screw 4 in the sides, being filled with the required quantity of sealant 2 intended for wet rooms after which the plug 1 is provided with a foliated closure 3 at the rear end of the plug 1A whereupon the plug 1 is airtight up until the time of mounting of the same.

One method for mounting an object 13 onto a floor, wall 12 or ceiling in wet rooms with a sealing layer, for example a toilet or fixture by drilling holes 11, plugging 1, applying a sealant 2 and mounting with a screw 10 entails according to the present invention, after drilling through the wet room surface layer, placing an airtight plug 1 there which is prepared with a sealant 2 for wet rooms. Then a screw 10 is screwed into the plug 1 so that the sealant 2 seeps out from plug 1 by emerging out through the thereby broken up plug with slits 1, towards the mounting wall into the drilled hole 11 and out towards the screw head 10A and the object 13 that is to be mounted, whereupon the surface layer is resealed.

According to the present method the quantity of sealing agent 2 is only provided which the plug 1 is prepared with and the fitter can carry a correct installation with the aid of centring guide 5 on a foliated airtight seal 3 on the rear end of the plug 1A.

An example of a known frequently occurring non-approved normal mounting is shown in FIG. 1. In this way, a plug is put into a hole drilled for this whereupon the sealing material is manually applied that conceals the plug. This means that it is instead difficult, if not impossible, to find the centre of the hole in the middle of the plug, which is required for correct installation. In the worst case, the screw will completely miss the inside of the plug and gets situated on the side of the hole and plug. The wet room surface layer is thus not sealed in such cases. This is also the case with the example shown in FIG. 2.

The aforementioned FIG. 2 shows a mounting where a sealant is not used in any way whatsoever. In this way, there is a great risk that moisture will enter the wall, etc. and thereby cause damp damage, even if the screw is correctly centred and mounted in the middle of the plug. The aforementioned way of mounting is unfortunately common among professionals and the layman. This is frequently due to ignorance of the currently applicable building standards.

FIG. 3 shows how the plug 1 according to the present invention is characterised and functions. The plug 1 is prepared with a sealant 2 intended for wet rooms. Upon screwing in the screw 10 the sealing agent 2 emerges out sideways through the broken pre-thinned slits 4 towards the walls of the hole, towards both the tile 15, as well as wet room sealing plaster 16. In addition the sealing agent 2 emerges out backwards towards the object 13 which will be mounted in wall 12, ceiling or floor.

FIG. 4 shows an example where the plug 1 according to the invention is used to mount an object 13 on a tiled wall 12. It can be clearly seen how the sealing material 2 emerges out to the walls of the hole 11, but also out towards the object 13 that will be mounted. In this way, the surface layer has to be resealed according to the applicable building standards.

FIG. 5 shows a picture of the foliated 3 centring guide 5. The airtight foil 3 will seal the filled plug 1 with sealing material 2, which is approved for wet rooms. In this way drying out of the sealing material is prevented 2 until mounting is performed.

FIG. 6 illustrates an object 13 that will be mounted where the hole 11 is small, which in normal cases would make mounting more difficult, since the sealing material 2 would hide the hole in the plug 1. By using the foliated centring guide 2, it is usually clearly seen where the hole on the plug 1 is situated, which makes it possible to perform an easy and correct installation.

FIG. 7-10 shows the plug 1, which is airtight by the plug 1, at the marked slits 4 being so tight that they keep the sealing material 2 fresh. The airtight slits 4 are however so thin that when screwed into by the screw 10 they expand like a standard plug, for a durable installation. The front part 1B of the plug 1, which is also tight, expands as is clearly shown in FIG. 3-4 when screwed into by the screw 10, by the slits 4 being split apart. To keep the plug 1 airtight and to simplify the correct screwing in of the screw 10 into the plug 1 a foiled 3 centring guide 5 is used which is at the rear end 1A of the plug 1.

### Summary

The character and function of the invention should have been clearly understood what is specified above and with the aid of the attached drawings.

The idea is to take a screw plug, ensure that it is airtight until mounting, and to fill it with an approved sealant for wet rooms and reseal the opening behind in order to prevent drying out of the sealing agent in the plug.

Obviously the plug comes in dimensions that suit different hole diameters e.g. 5.5 mm-6 mm-8 mm-10 mm. The field of application includes most uses for wall plugs.

When you screw in the screw 10 the sealant 2 seeps out from the plug 1 and seals both the hole 11 and out towards the screw head 10 A and the object 13 that is to be fixed and the open wet room surface layer that was created by drilling a hole 11 into it has to be resealed. Whether it is a floor, wall 12 or ceiling.

This results in a clear improvement, since it is up to the fitter to seal the surface layer. This of course applies to professional groups who work with wet room installations e.g. plumbers, carpenters, and electricians as well as a number of “do it yourselfers”, who frequently do not restore holes in places that require a surface layer.

### Advantages of the Invention

It is a simpler method, that quickly achieves a correct installation.
It is easier to carry a packet of plugs, than a big sealant gun
In awkward places it may perhaps sometimes be manipulated, or is almost impossible to get the sealing material in there, and then it is ignored, whereupon the surface layer is broken. Now it is instead easy to put a plug there which is already prepared for the purpose.
The method is time-saving and environment saving.

The invention is of course not limited to what is described above and to the designs shown in the attached drawings. Modifications are possible, particularly when it comes to the characteristics of different parts, or through use of equivalent technology, without departing from the scope of protection of the invention, such as what is defined in the patent claims.

1. A plug comprising:
a body having pre-thinned slits and configured to receive a fastener, wherein the body is filled with a quantity of sealant; and
a closure affixed to an end of the body;
wherein the body and closure are airtight and the pre-thinned slits are configured to break up due to internal pressure in the plug from a fastener inserted into the plug allowing at least some of the quantity of sealant to be pressed out through the plug.

2. The plug of claim 1, wherein the closure includes a centering guide.

3.-7. (canceled)

8. A plug comprising:
a body having defined portions and configured to receive a fastener;
a covering affixed to one end of the body, wherein the covering and the body form an enclosed area; and
sealant disposed within the enclosed area;
wherein, the defined portions are configured to break upon insertion of a fastener in the plug and allow a portion of the sealant to escape from the enclosed area.

9. The plug of claim 8, wherein the covering includes a centering guide.

10. The plug of claim 8, wherein the covering is configured to be punctured by a fastener and allow a portion of the sealant to escape from the enclosed area.

11. The plug of claim 8, wherein the defined portions are pre-thinned portions.

12. The plug of claim 8, wherein the body is made of plastic.

13. The plug of claim 11, wherein the defined portion of the body are characterized by a portion of the body in which the plastic is thinner than other portions of the body.

14. The plug of claim 8, wherein the covering is made of metallic foil.

15. The plug of claim 8, wherein the enclosed area is substantially airtight before insertion of a fastener.
